(19) United States
(12) Patent Application Publication
(10) Pub. No.: US 2015/0271601 A1
(43) Pub. Date: Sep. 24, 2015

(54) UNIQUE INAUDIBLE SOUND SIGNATURES

(71) Applicant: International Business Machines Corporation, Armonk, NY (US)

(72) Inventors: Gregory Jensen Boss, Saginaw, MI (US); Andrew R. Jones, Round Rock, TX (US); Kevin C. McConnell, Austin, TX (US); John Elbert Moore, JR., Indianapolis, IN (US)

(73) Assignee: International Business Machines Corporation, Armonk, NY (US)

(21) Appl. No.: 14/218,395

(22) Filed: Mar. 18, 2014

(51) Int. Cl. H04R 5/00

(52) U.S. Cl. CPC H04R 5/00; H04R 2430/00

(57) ABSTRACT

A method includes a computing device a method includes: assigning unique inaudible sound signatures for vehicles; mounting at least radio device containing at least one of the unique inaudible sound signatures in a vehicle; a first computer device causing the at least one of the radio device to broadcast the at least one of the unique inaudible sound signatures; a second computer device causing at least one processing device to receive the broadcasted at least one of the unique inaudible sound signatures; and determining specific vehicle information based upon the received at least one of the unique inaudible sound signatures.

### BACKGROUND

The present invention relates to unique inaudible sound signatures, and more specifically, to using unique inaudible sound signatures determine specific vehicle information.

### SUMMARY

According to one aspect of the present invention, a method includes a computing device a method includes: assigning unique inaudible sound signatures for vehicles; mounting at least radio device containing at least one of the unique inaudible sound signatures in a vehicle; a first computer device causing the at least one of the radio device to broadcast the at least one of the unique inaudible sound signatures; a second computer device causing at least one processing device to receive the broadcasted at least one of the unique inaudible sound signatures; and determining specific vehicle information based upon the received at least one of the unique inaudible sound signatures.

According to another aspect of the present invention, a system including: one or more processors, one or more computer-readable memories and one or more computer-readable, tangible storage devices; a first computing module operatively coupled to at least one of the one or more storage devices for execution by at least one of the one or more processors via at least one of the one or more memories, configured to broadcast at least one assigned unique inaudible sound signature for a vehicle using at least one radio device mounted attached to the vehicle; a second computing module operatively coupled to at least one of the one or more storage devices for execution by at least one of the one or more processors via at least one of the one or more memories, configured to receive the broadcasted at least one assigned unique inaudible sound signature using at least one processing device; and a determining module operatively coupled to at least one of the one or more storage devices for execution by at least one of the one or more processors via at least one of the one or more memories, configured to determine specific vehicle information for the vehicle based upon the received at least one assigned unique inaudible sound signature.

According to yet another aspect of the present invention, a computer program product including: one or more computer-readable, tangible storage medium; program instructions, stored on at least one of the one or more storage medium, to broadcast at least one assigned unique inaudible sound signature for a vehicle using at least one radio device mounted attached to the vehicle; program instructions, stored on at least one of the one or more storage medium, to receive the broadcasted at least one assigned unique inaudible sound signature using at least one processing device; and program instructions, stored on at least one of the one or more storage medium, to determine specific vehicle information for the vehicle based upon the received at least one assigned unique inaudible sound signature.

### BRIEF DESCRIPTION OF THE SEVERAL VIEWS OF THE DRAWINGS

FIG. 1 shows a flowchart according to an embodiment of the present invention.

FIG. 2 shows an exemplary implementation according to an embodiment of the present invention.

FIG. 3 shows another exemplary implementation according to an embodiment of the present invention.

FIG. 4 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

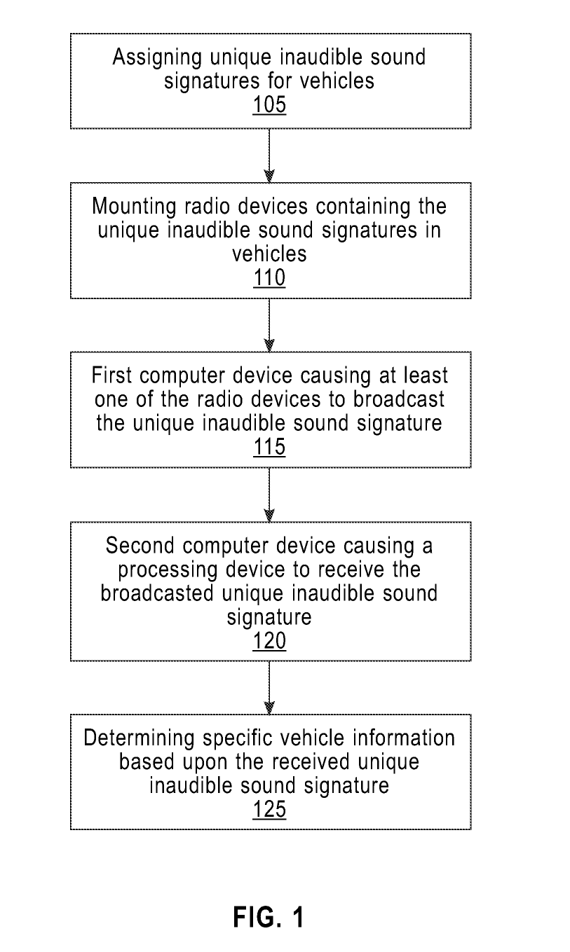

Now referring to FIG. 1, an embodiment of the present invention uses unique inaudible sound signatures for vehicles. They would serve as extensions to unique aspects of a vehicle (VIN, license plate number, make/model, etc). The inaudible signature would be broadcast from each vehicle either continuously or periodically and could be read by devices which record these audio signatures. Police or emergency service personal could use this type of device to aid in the recovery of stolen vehicles or criminal activity. Others uses extend to vehicle service centers, public parking, child monitoring, notification for the blind, etc.

Assigning a unique inaudible sound signature to each vehicle would be similar to a network card MAC address or a VIN number to a vehicle. The vehicle would then broadcast this inaudible sound signature. Various devices could then read this frequency and look up specific information once identified (owner information, outstanding parking tickets, previous infractions, APBs, etc). The signature could also include a sub carrier signal that includes a variable component (some element that changes based on triggers). The first few bits (or first few digits of the broadcast frequency) would be assigned to a manufacturer with model type automobile being assigned the next few bits/digits of broadcast frequency) with the remaining necessary # of bits/frequency being allocated to the next unique VIN.

Still referring to FIG. 1, a process according to an embodiment of the present invention assigns unique inaudible sound signatures for vehicles (105). The process then places radio devices containing the unique inaudible sound signatures in vehicles (110). A first computer device using a radio transceiver then broadcasts the unique inaudible sound signature (115). As will be explained with other embodiments, each manufactured vehicle will include a radio transceiver containing the unique inaudible sound signature. The present embodiment process continues by having a second computer device cause a processing device to receive the broadcasted unique inaudible sound signature (120). Once the processing device receives the unique inaudible sound signature specific vehicle information can be determined (125). The specific vehicle information can be used by many end user devices. Examples of such of end user devices will be described hereafter.

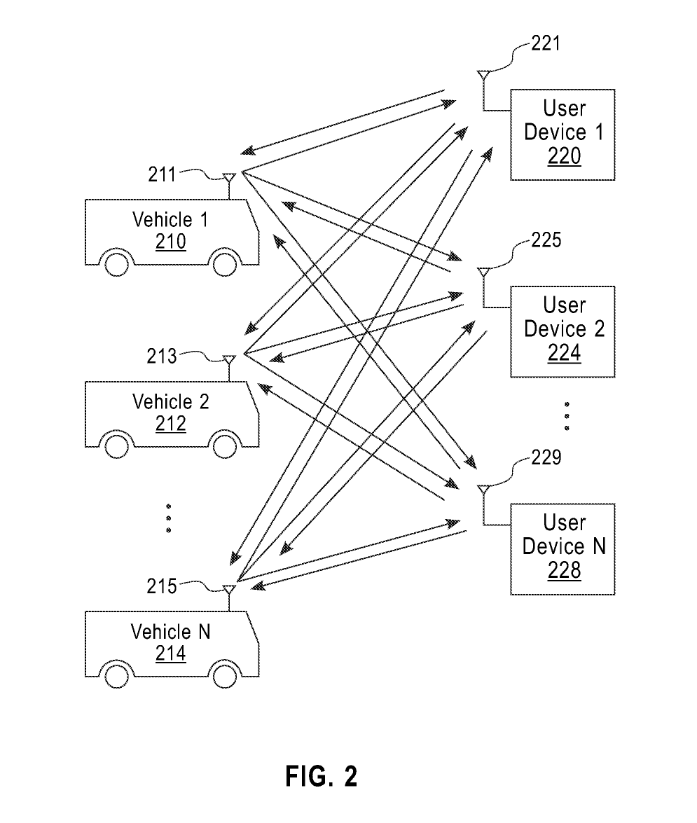

Referring to FIG. 2, an exemplary implementation according to an embodiment of the present invention is depicted. A plurality of vehicles (210, 212 and 214) are assigned unique inaudible sound signatures. These unique inaudible sound signatures are transmitted via their respected antennas (211, 213 and 215) under the control on-board computers and radio transceivers. As described above each of these inaudible sound signatures are unique to the specific vehicle. The vehicles may be automobiles, buses, trucks or motorcycles. A government authority assigns frequencies to vehicle manufacturers which in turn assigns frequencies to each vehicle. The manufacturer registers the assigned frequencies with the government authority. The vehicles then broadcast the unique inaudible sound signatures either constantly or periodically based on a trigger (time, event, location, received signal, etc). Optionally, the vehicles may broadcast other secondary dynamic signatures. Such dynamic signatures could include SOS, destination, unauthenticated driver or other assist efforts.

Still referring to FIG. 2, a plurality of computer type user devices (220, 224 and 228) are able to receive the unique inaudible sound signatures via their respective antennas (221, 225 and 229). The user devices (220, 224 and 228) include internal transceiver and processing devices capable of receiving the unique inaudible sound signatures being transmitted by the vehicles (210, 212 and 214). Upon receiving the unique inaudible sound signatures, the user devices (220, 224 and 228) are able to determine specific vehicle information about each vehicle. In one embodiment, user devices (220, 224 and 228) are able to detect “silent” running vehicles moving near visual impaired people and emitting audio warnings. “Silent” running vehicles may include hybrid, hydrogen or electrical powered vehicles. In another embodiment, the user devices (220, 224 and 228) can be placed on motorcycles or within other vehicles to issue warnings to the drivers that another vehicle may be in a blind spot.

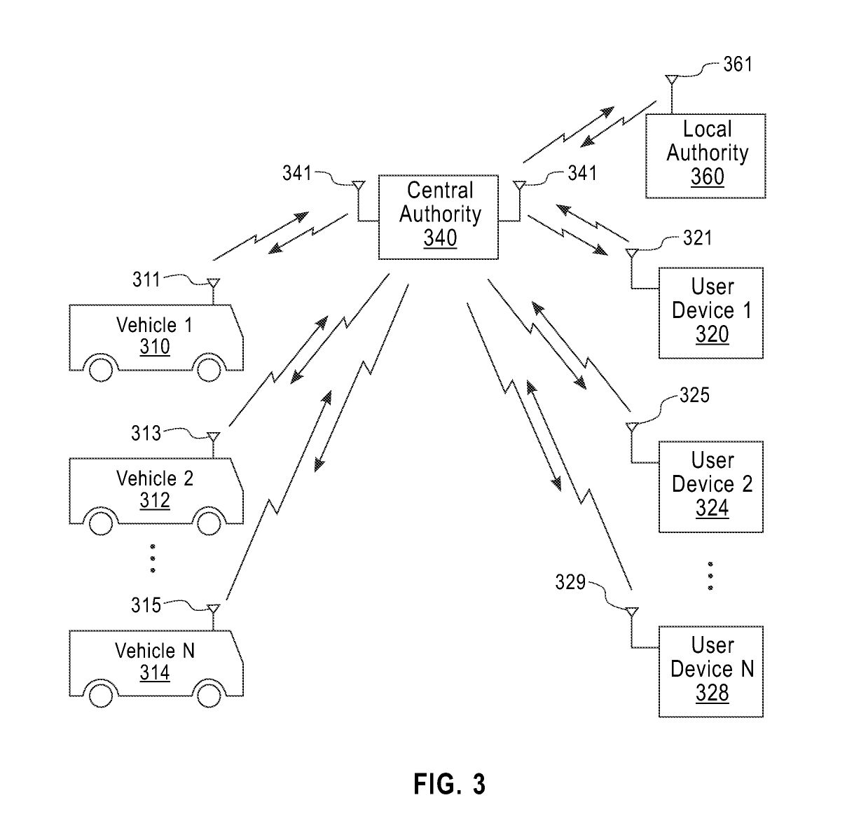

Referring to FIG. 3, another exemplary implementation according to an embodiment of the present invention is depicted. A plurality of vehicles (310, 312 and 314) are assigned unique inaudible sound signatures. These unique inaudible sound signatures are transmitted via their respected antennas (311, 313 and 315) under the control on-board computers and radio transceivers. As described above each of these inaudible sound signatures are unique to the specific vehicle. The vehicles may be automobiles, buses, trucks or motorcycles. A government authority assigns frequencies to vehicle manufacturers which in turn assigns frequencies to each vehicle. The manufacturer registers the assigned frequencies with the government authority. The vehicles then broadcast the unique inaudible sound signatures either constantly or periodically based on a trigger (time, event, location, received signal, etc). Optionally, the vehicles may broadcast other secondary dynamic signatures. Such dynamic signatures could include SOS, destination, unauthenticated driver or other assist efforts.

Still referring to FIG. 3, a computer type central authority 340 receives the broadcasted unique inaudible sound signatures from the vehicles (310, 312 and 314). The computer type central authority 340 includes a network of transceivers and antennas 241. An internal processing device receives the unique inaudible sound signatures and preforms a look up to determine specific vehicle information based on the received unique inaudible sound signature. The broadcasting of unique sound signatures can be event based, such as the vehicle being at a specific location, time of day or upon a received signal from the central authority 340. The central authority 340 then can broadcasts the specific vehicle information to a plurality of computer type user devices (320, 324 and 328) and local authorities 360. The user devices (320, 324 and 328) and the local authority 360 include internal transceiver and processing devices capable of receiving the unique inaudible sound signatures and the specific vehicle information being transmitted by central authority 340. The user devices (320, 324 and 328) and the local authority 360 further include the capability of transmitting, via internal transceivers (321, 325, 329 and 361), a request signal to the central authority 340 to receive the unique inaudible sound signatures and determine specific vehicle information about each vehicle. In response the ping request user devices (320, 324 and 328) are able to detect “silent” running vehicles moving near visual impaired people and emits audio warnings. “Silent” running vehicles may include hybrid, hydrogen or electrical powered vehicles. In still another embodiment, the local authority 360 can use the ping request to track stolen vehicles.

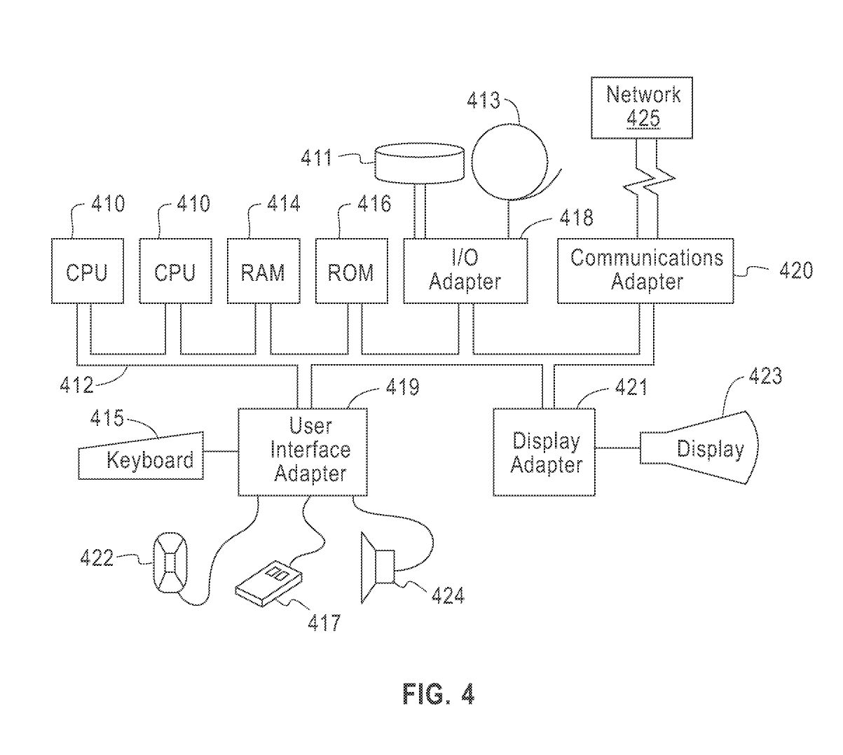

Referring now to FIG. 4, this schematic drawing illustrates a hardware configuration of an information handling/computer system in accordance with the embodiments of the invention. The system comprises at least one processor or central processing unit (CPU) 410. The CPUs 410 are interconnected via system bus 412 to various devices such as a random access memory (RAM) 414, read-only memory (ROM) 416, and an input/output (I/O) adapter 418. The I/O adapter 418 can connect to peripheral devices, such as disk units 411 and tape drives 413, or other program storage devices that are readable by the system. The system can read the inventive instructions on the program storage devices and follow these instructions to execute the methodology of the embodiments of the invention. The system further includes a user interface adapter 419 that connects a keyboard 415, mouse 417, speaker 424, microphone 422, and/or other user interface devices such as a touch screen device (not shown) to the bus 412 to gather user input. Additionally, a communication adapter 420 connects the bus 412 to a data processing network 425, and a display adapter 421 connects the bus 412 to a display device 423 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
assigning unique inaudible sound signatures for vehicles;
mounting at least radio device containing at least one of the unique inaudible sound signatures in a vehicle;
a first computer device causing the at least one of the radio device to broadcast the at least one of the unique inaudible sound signatures;
a second computer device causing at least one processing device to receive the broadcasted at least one of the unique inaudible sound signatures; and
determining specific vehicle information based upon the received at least one of the unique inaudible sound signatures.

2. The method according to claim 1, wherein the broadcast is triggered by an event.

3. The method according to claim 2, wherein the triggering event is time based.

4. The method according to claim 2, wherein the triggering event is based on location of the at least one radio device.

5. The method according to claim 2, wherein the triggering event is based on a received signal.

6. The method according to claim 1, wherein the at least one processing device is located within at least one personal user device.

7. The method according to claim 1 wherein the at least one processing device is part of a central authority which is able to provide said specific vehicle information to others as a result of the received at least one of the unique inaudible sound signatures.

8. A system comprising:
one or more processors, one or more computer-readable memories and one or more computer-readable, tangible storage devices;
a first computing module operatively coupled to at least one of the one or more storage devices for execution by at least one of the one or more processors via at least one of the one or more memories, configured to broadcast at least one assigned unique inaudible sound signature for a vehicle using at least one radio device mounted attached to the vehicle;
a second computing module operatively coupled to at least one of the one or more storage devices for execution by at least one of the one or more processors via at least one of the one or more memories, configured to receive the broadcasted at least one assigned unique inaudible sound signature using at least one processing device; and
a determining module operatively coupled to at least one of the one or more storage devices for execution by at least one of the one or more processors via at least one of the one or more memories, configured to determine specific vehicle information for the vehicle based upon the received at least one assigned unique inaudible sound signature.

9. The system according to claim 8, wherein the broadcast is triggered by an event.

10. The system according to claim 9, wherein the triggering event is time based.

11. The system according to claim 9, wherein the triggering event is based on location of the at least one radio device.

12. The system according to claim 9, wherein the triggering event is based on a received signal.

13. The system according to claim 8, wherein the at least one processing device is located within at least one personal user device.

14. The system according to claim 8, wherein the at least one processing device is part of a central authority which is able to provide said specific vehicle information to others as a result of the received at least one assigned unique inaudible sound signature.

15. A computer program product comprising:
one or more computer-readable, tangible storage medium;
program instructions, stored on at least one of the one or more storage medium, to broadcast at least one assigned unique inaudible sound signature for a vehicle using at least one radio device mounted attached to the vehicle;
program instructions, stored on at least one of the one or more storage medium, to receive the broadcasted at least one assigned unique inaudible sound signature using at least one processing device; and
program instructions, stored on at least one of the one or more storage medium, to determine specific vehicle information for the vehicle based upon the received at least one assigned unique inaudible sound signature.

16. The computer program product according to claim 15, wherein the broadcast is triggered by an event.

17. The computer program product according to claim 16, wherein the triggering event is time based.

18. The computer program product according to claim 16, wherein the triggering event is based on location of the at least one radio device.

19. The computer program product according to claim 15, wherein the at least one processing device is located within at least one personal user device.

20. The computer program product according to claim 15, wherein the at least one processing device is part of a central authority which is able to provide said specific vehicle information to others as a result of the received at least one assigned unique inaudible sound signature.
